(19) United States
(12) Patent Application Publication
(10) Pub. No.: US 2024/0037924 A1
(43) Pub. Date: Feb. 1, 2024

(54) INVARIANT REPRESENTATIONS OF HIERARCHICALLY STRUCTURED ENTITIES

(71) Applicant: Merck Patent GmbH, Darmstadt (DE)

(72) Inventor: Helmut LINDE, Darmstadt (DE)

(73) Assignee: Merck Patent GmbH, Darmstadt (DE)

(21) Appl. No.: 18/039,810

(22) PCT Filed: Dec. 1, 2021
(86) PCT No.: PCT/EP2021/083707

§ 371 Date: Jun. 1, 2023

(30) Foreign Application Priority Data
Dec. 2, 2020 (EP) 20211253.8

(51) Int. Cl. G06V 10/82; G06V 10/86; G06V 10/75; G06V 10/772

(52) U.S. Cl. CPC G06V 10/82; G06V 10/86; G06V 10/76; G06V 10/772; G06V 10/753

(57) ABSTRACT

A method for processing digital image recognition of invariant representations of hierarchically structured entities can be performed by a computer using an artificial neural network. The method involves learning a sparse coding dictionary on an input signal to obtain a representation of low-complexity components. Possible transformations are inferred from the statistics of the sparse representation by computing a correlation matrix. Eigenvectors of the Laplacian operator on the graph whose adjacency matrix is the correlation matrix from the previous step are computed. A coordinate transformation is performed to the base of eigenvectors of the Laplacian operator, and the first step is repeated with the next higher hierarchy level until all hierarchy levels of the invariant representations of the hierarchically structured entities are processed and the neural network is trained. The trained artificial neural network can then be used for digital image recognition of hierarchically structured entities.

The hereby described invention discloses a method for processing digital image recognition by creating invariant representations of hierarchically structured entities.

The invention deals with the technological area of digital image recognition by using an artificial neural network.

Digital image processing as a part of digital signal processing, which also covers closely related topics like voice recognition and others, has nowadays gained a lot of industrial applications. Most common use cases include for instance an automatic quality inspection of products in the production chain or in general all applications where digital images are taken and processed for a specific purpose. Necessary tools for digital image processing include furthermore image denoising, object recognition or, in case of related topics e.g. speech recognition.

Standard ways to perform digital image processing see a computer which has access to the to be processed digital images and performs a software program executing specific algorithm. What kind of algorithms depends on the countless use cases and the kind of the processed images. The algorithms then process the digital images by identifying specific objects with edge recognition and so on. It is also common to adapt the images for a more efficient processing. For example the finding and analyzing of periodic image errors can be performed by the use of fourier transformation on the images, because periodic errors are much easier to recognize in the frequency domain.

During the last years the use of machine learning approaches especially by applying software based artificial neural networks (ANN) for the matter of digital image, or rather in general signal processing has become more and more common. Using such an ANN leads to a completely different workflow for the image or signal processing. Here there is no longer a fix algorithm which processes the image or signal in a predetermined way. Usually you have a suitable plain ANN and feed it with training data in form of the signals or images you want to process. The signals or images in the training data contain the wanted properties leading to the ANN being trained to recognize such wanted properties. If you want to recognize a specific type of image error e.g. in form of a specific object type then you train the ANN with images which contain those objects. The ANN then learns to recognize the wanted properties by connecting the neurons it consists of in the respective way—similar like a neural network in the human brain. A big difference to the standard software algorithm approach is based in the fact, that the whole process is no longer predetermined. The creator or rather programmer of the plain ANN cannot predict how the ready trained ANN is structured if he doesn't know the exact training data and how it is applied. The user of the ANN who applies the training data usually doesn't know it either as he doesn't need to know. For him it is just important that the trained ANN recognizes the wanted properties. The flexibility of the such ANNs is a big advantage over the classic approach of using fix algorithms.

Nonetheless the use of such ANNs still shows a lot problems. One standard problem in machine learning is to encode a signal in a way which is consistent with the structure of the source of the signal, as opposed to the way how the signal is observed. For example, in computer vision one often aims at encoding an image, the signal, in a way that describes the content of the image, e.g. to determine if the image contain a face, rather than the pixel-by-pixel information, which is the direct observation.

Many algorithms are known to perform such an encoding, for example Convolutional Neural Networks as a special embodiment of ANNs or a variety of Sparse Coding algorithms. The problem with the known algorithms is that they do not capture adequately the hierarchical structure of an input signal. Hierarchical means in that sense, for example: pixels form lines, lines form polygons, polygons form 3D bodies, and so on. The reason for such behavior is, that they are not designed to learn the transformations which keep the components of the signal invariant; e.g. a rotation of a 3D object in space.

This leads to a specific problem. Consider a signal, i.e. a data set which consists of a number of blocks of the same size which can be interpreted in the same way; e.g. a sequence of images. Assume that this signal represents an hierarchically structured entity, e.g. in the case of images a hierarchy of “could be pixels”—lines—polygons—3D-objects. For that entity certain transformations are possible on the source, e.g. a 3D-object moves in spade. The problem is now to express this signal in a way which exhibits the nature of the source while being invariant under the mentioned transformations. For example if the 3D object is a cube, from the desired representation it is obvious that there is a cube, independent of the position of the cube in space.

There are essentially two known methods of how these transformations can be processed by artificial neural networks today:
1. The structure of the network is chosen so well that certain transformations are automatically contained in it, so to speak. For example: In a so-called pooling layer, features of an image from the layer below are aggregated over a larger image section and a certain translation invariance is automatically achieved.
2. The variability of the training data is artificially increased by data augmentation. This means that the neural network not only learns from different images, but also from a large number of rotated, compressed or otherwise transformed versions of these images.

The problem in both cases is that the programmer has to know the transformation. This is not a big problem for simple cases such as translations, but for more complex transformations, such as 3D-rotations, it would be helpful if the computer could learn these independently from the input data. With the second method in particular, there is additionally the problem that it is quite time-consuming to produce the augmented data and that the resource consumption during training increases enormously.

The task of this patent application is therefore to find and disclose a method and/or system for digital signal and/or image recognition which can overcome the known problems of the state of the art with the processing of the mentioned invariant representations of hierarchically structured entities.

This task has been solved by a method for processing digital image recognition of invariant representations of hierarchically structured entities, performed by a computer using an artificial neural network, which comprises the method steps of learning a sparse coding dictionary by the computer on an input signal to obtain a representation of low-complexity components, inferring possible transformations from the statistics of the sparse representation by computing a correlation matrix between the low-complexity components with the computer resulting in invariance transformation of the data now encoded in the symmetries of the correlation matrix, computation of the eigenvectors of the Laplacian operator on the graph whose adjacency matrix is the correlation matrix from the previous step, performing a coordinate transformation to the base of eigenvectors of the Laplacian operator, repeating with step one with the next higher hierarchy level until all hierarchy levels of the invariant representations of the hierarchically structured entities are processed and the neural network is trained and using the trained artificial neural network to the digital image recognition of hierarchically structured entities, creating representations of those entities which are invariant under the transformations learnt in the previous steps. The new method creates therefore a trained neural network, which consists of multiple layers and is able to recognize specific objects regardless of invariant representation in which they are shown in the examined digital signals/images.

Advantageous and therefore preferred further developments of this invention emerge from the associated subclaims and from the description and the associated drawings.

Preferred further developments of the process include for example but not limited to that:
1. That the sparse coding dictionary learning comprises a first processing step of recognizing patterns in the input signal data, wherein those patterns represent specific recurring combinations in the input data.
2. That the representation of low-complexity components is created by computing a correlation matrix of co-occurrences of neuron activations.
3. That the next higher hierarchy level gets the result of the coordinate transformation from the base of eigenvectors as input data.
4. That the using of the trained artificial neural network to digital image recognition comprises image denoising, object recognition, speech recognition and text recognition.
5. That text and object recognition comprises to solve captchas or to recognize chemical structures in images.

Another solution to the task is additionally an artificial neural network established on a computer by performing one of the previously disclosed methods.

A further solution to the task is also a software product performing one of the disclosed methods and establishing the disclosed artificial neural network on a computer.

The method, artificial neural network and software product according to the invention and functionally advantageous developments of those are described in more detail below with reference to the associated drawings using at least one preferred exemplary embodiment. In the drawings, elements that correspond to one another are provided with the same reference numerals.

The drawings show:

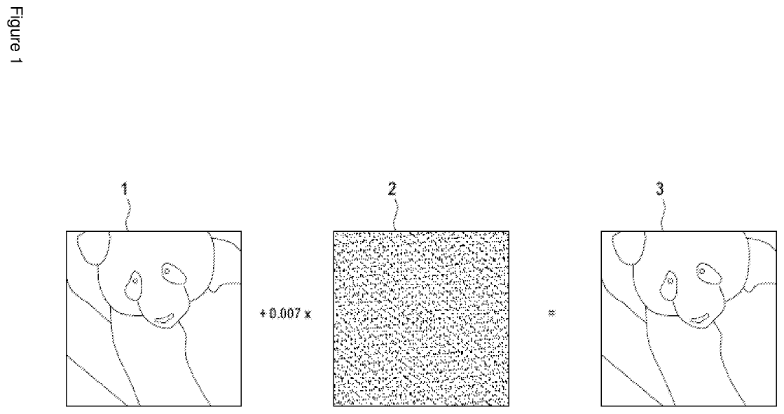

FIG. 1: an overview about working problems of applied artificial neural networks

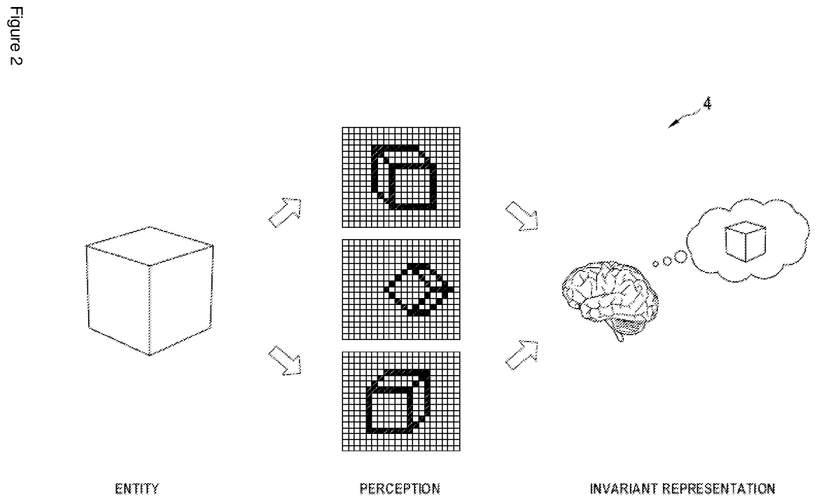

FIG. 2: the problem to handle invariant representations for artificial neural networks

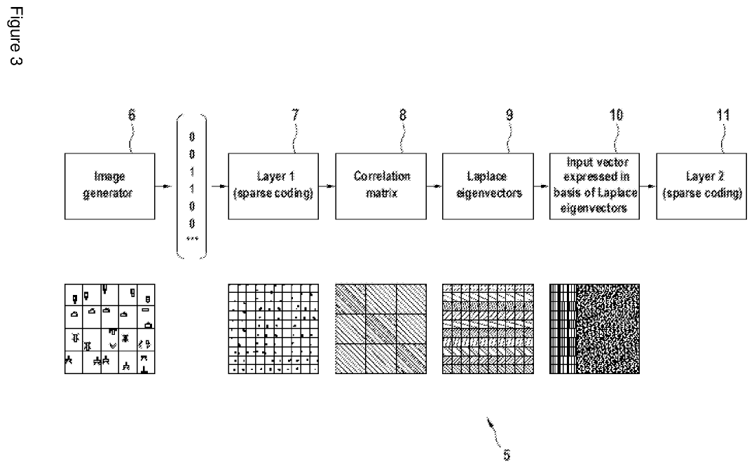

FIG. 3: a schematic overview about the invented method using a working example

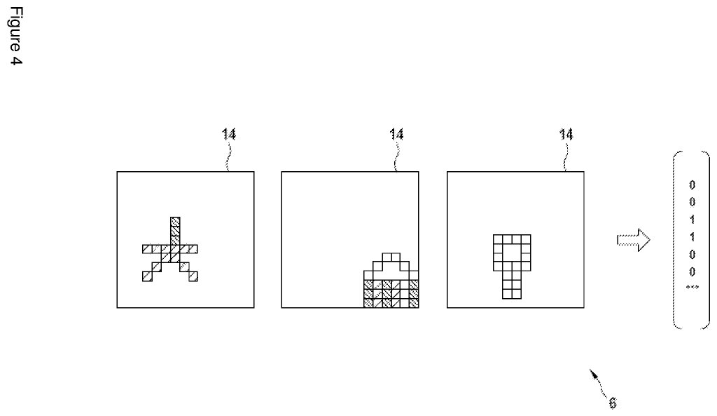

FIG. 4: an example for an image generator according to the invention

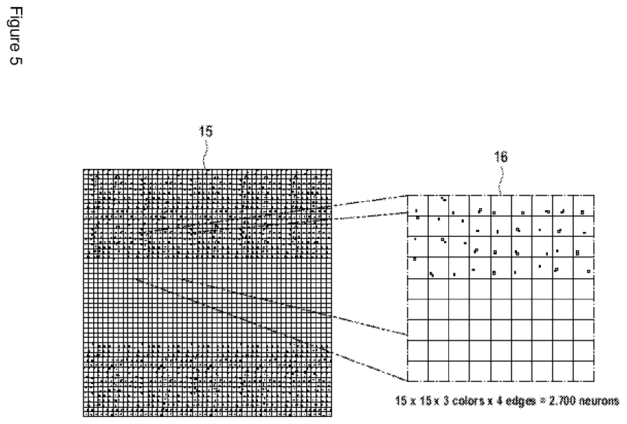

FIG. 5: an overview about the first layer receptive fields

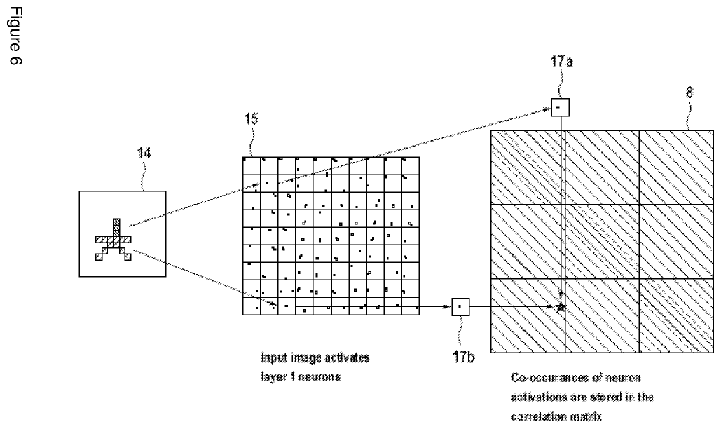

FIG. 6: the method step of computing the correlation matrix

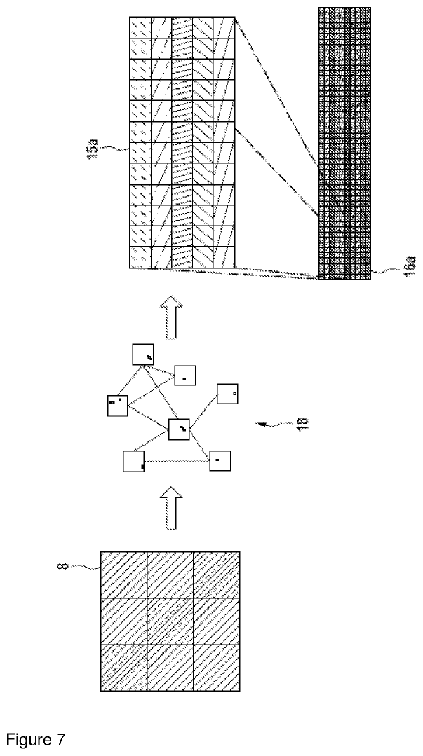

FIG. 7: the computing of Laplacian eigenvectors to find symmetry in the matrix

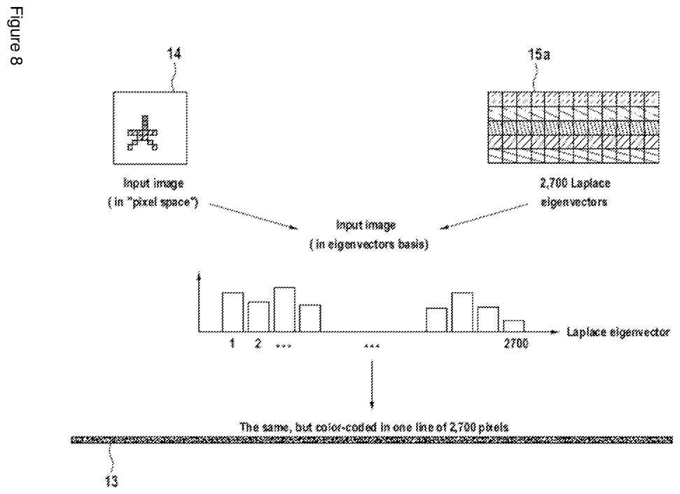

FIG. 8: the use of the eigenvectors to express input images

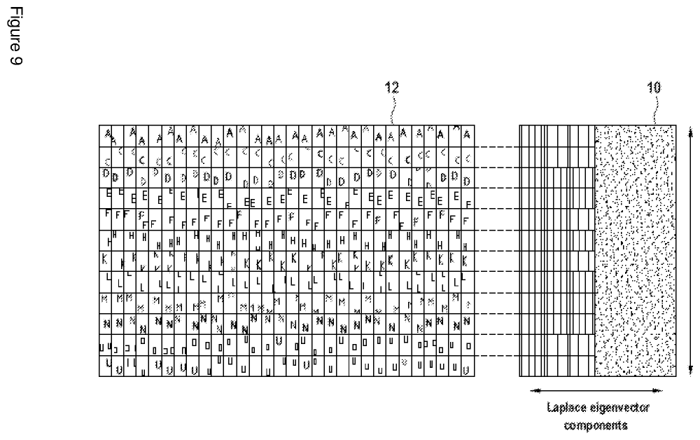

FIG. 9: perception of the trained ANN of invariance in color and position

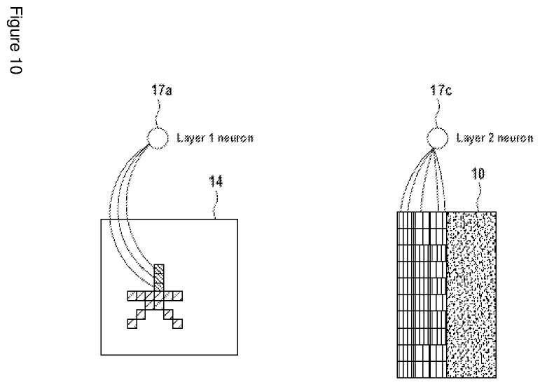

FIG. 10: the correlation between first layer and second layer neurons

The solution is a software product which runs on a suitable computer and executes the following method in form of an algorithm on the input signal, which is preferably at least on digital image:
1. Perform sparse coding, as a form of “dictionary learning”, on the input signal to obtain a representation of low-complexity components; e.g. line segments in the case of an image. These low-complexity components are also called “atoms”.
2. Infer the possible transformations from the statistics of the sparse representation: Compute the correlation matrix 8 between the atoms, i.e. “count” how often a given pair of atoms is activated simultaneously by the same input data point. An “allowed” invariance transformation of the data is now encoded in the symmetries of this correlation matrix 8.
3. Perform a coordinate transformation to the base of eigenvectors of the inferred transformation. In this new basis, the problem of encoding the next higher hierarchy level 11 is reduced in dimensionality
4. Repeat the algorithms, starting at step 1. with the next higher hierarchy level 11.

The algorithm of the invented method is hereinafter explained more detailed by showing a working example using the FIGS. 1 to 10.

First FIG. 1 shows an example to explain about the problems with the current performance of artificial intelligence. The picture 1 on the left hand side in FIG. 1 obviously shows a panda. And it is also recognized by a state-of-the-art neural network as a panda with a confidence of 57.7%. But it has to be considered that such performance does not always exists. The image 2 in the middle of FIG. 1 seems to show random noise, but has actually been chosen very carefully. The algorithm thinks that this might be a nematode with very low confidence, but that is not the point. If the color values of that image 2 are multiplied with a very small number—less than 1%—and added, pixel by pixel, to the Panda image 1 the result 3 still looks very much like a Panda to the human eye. But our state-of-the-art neural network is almost certain now that the picture 3 is showing a gibbon, resulting in a total wrong evaluation.

A panda is something pretty complex. But the same issues also appear with simpler objects. FIG. 2 shows the perception of a cube 4. In how many different ways is it possible to see a cube? A cube has three rotational degrees of freedom and three translational ones. Maybe 100 steps in each dimension can be distinguished. Then there are 100\hat{ }6=10\hat{ }12 (one trillion) different pictures that a cube can create on your retina. And different colors, textures or light situations are not even considered yet.

The human brain still manages to recognize a cube without any effort—because it has somehow formed an abstract idea of what a ‘cube’ is: The invariant representation 4.

Even more impressive is how few examples we need to create these invariant representations. How many pandas or panda pictures a human brain has been processed in its life? Maybe a few dozen. How many pandas does a child need to see before it can recognize pandas? Maybe one or three or at maximum about ten. So a handful of examples is enough to learn for the human brain and then it can recognize every panda despite the astronomic number of possibilities how it can look like.

This ability of the human brain to form invariant representations is probably the biggest difference to AI algorithms according to the state of the art.

This problem needs to be solved not only for image recognition but also for abstract thinking. Because in the end abstract thoughts are always tied to sensory signals. It is not possible to think of a mathematical formula without somehow visualizing it—either its written form or its meaning or the objects it represents. That means that the problem of invariant representations is currently blocking the development of strong AI. A strong AI would enable a superhuman progress on many other scientific problems.

FIG. 3 gives now an overview about the single steps of the algorithm 5 according to invented method to deal with those problems of invariant representations.

The following figures explain the single method steps using a specific working example, starting with FIG. 4. In that working example 30 different input images 14 using 3 colors are provided by an image generator 6, with a range of 15×15 pixels wherein the colors are permutated randomly. Those different images 14 are then converted to a resulting input vector 10 with 15×15×3=775 elements.

The next method step explained in FIG. 5 is to recognize patterns in the input data 14. FIG. 5 shows there an example for all recognized patterns 15 in the input images 14 in the left side of the figure, while the right side shows a cutout with special selected patterns 16. A “pattern” is a specific combination of pixels that are most common in combination. For example, three red pixels occur side by side much more frequently than three red pixels at random locations of the matrix. There are different algorithms that can be used to find such patterns; at least approximately. For example, see “Dictionary Learning” in the field of Sparse coding.

FIG. 6 now shows the computing of a correlation matrix 8. Each input image 14 consists of a combination of patterns 15; here in the example, a combination of short line segments. When a new input image 14 arrives, it is calculated which neurons 17a, 17b of layer 17 are activated, i.e. which patterns 15 are recognized. In the example of the stick figure above, for example, five patterns 15 could be detected: One head, two legs and two arms. For each of these five patterns 15, a neuron 17a, 17b in layer 17 becomes “active”. Now the correlation matrix 8 is updated accordingly. The correlation matrix 8 simply counts for each pair of two neurons 17a, 17b how often they have become active together, across all past input images 14. In the example above, there are five activated neurons, i.e. 5*4/2=10 pairs of simultaneously activated neurons 17a, 17b. The corresponding ten entries of the correlation matrix 8 will thus be increased by one each.

The decisive observation in the next step according to FIG. 7 is that a symmetry in the probability distribution of the input images 14 can express itself—at least approximately—in a symmetry of the correlation matrix 8. Take, for example, the symmetry transformation, which pushes all images 14 one pixel to the right. This transformation does not change the probability distribution of the images 14—an image and its twin shifted one to the right occur with the same probability in the input data 14. This is transferred to the activation probabilities of neurons 17a, 17b in layer 17: A neuron that recognizes a pattern 15 is as often activated as its “twin” that recognizes the pattern that has shifted one pixel to the right. The correlation matrix 8 also inherits this symmetry. The correlation between two neurons is the same as the correlation between the other two neurons, each detecting the pattern that has shifted one pixel to the right.

A symmetry in a matrix can now be found by computing the Laplacian eigenvectors 9. For an exact symmetry, non-localized self-vectors result, essentially a kind of Fourier transformation, where the axis along which is transformed is the trace of the symmetry transformation. This is done essentially by considering three points:
1. Regard the correlation matrix 8 as edge weight of a graph 18 with 2700 nodes
2. Compute the Laplacian eigenvectors 9 (“vibration modes”) of this graph 18, meaning the eigenvectors of the Laplacian operator 9 on the graph 18
3. Visualize the eigenvectors 15a, 16a in terms of the receptive fields of the graph nodes

In the working example there are 2700 neurons in the first layer 7. Therefore the correlation matrix 8 has the size 2700×2700. Their eigenvectors 9 therefore also have a dimension of 2700. Now, if an input image 14 activates some neurons, it can be seen as a vector 10 in a 2700-dimensional space. In the working example, five entries would be equal to one and all other zero. This vector 10 can now be expressed in another base, namely in the base of the Laplacian eigenvectors 9. So you get a new, transformed vector 10 with 2700 components. This new vector 10 is visualized as a long line of color-coded pixels 13 (see FIG. 8).

If the lines of color-coded pixels are drawn for many input images 14, the lines for similar images are similar. “Similar images” means here those images which show the same letter, regardless of their color and position. So the system of the ANN has learned, in a way, that color and position are not as important as the type of letter. FIG. 9 shows the result of that point for the first layer 7 as a kind of fingerprint, where you can see an overall test input image 12 with lots of different letters in many different colors and positions. This overall test input image 12 shows invariance regarding color and position in the resulting input vector 10.

The similarities between the lines of pixels 13, which we have already recognized visually easily, can now be used algorithmically. The second layer 11 is therefore built in a way that basically works the same way as for the first layer 7, but gets the resulting “pixel lines” 13 from FIG. 8 as input. By doing this second layer 11 learns to recognize letters regardless of their color and position. FIG. 10 shows that context with the layer 1 neuron 17a in an input image 14 and the corresponding layer 2 neuron 17c in the input vector 10.

The algorithm has learned therefore in an unsupervised way to distinguish letters and other symbols independent of their position and color. By looking only at the statistical properties of the input data, it has “discovered” the concepts of translational invariance and color invariance. That means by applying the algorithm on an input signal, an ANN is trained to handle the invariant representations of the processed signals or rather images 14. The invented method therefore results in an specific trained neural network consisting of multiple layers 7, 11 handling the different hierarchy levels of the input signal or images 14.

In principle, possible further preferred embodiments could comprise of very different software products which use the described method, for example, to perform tasks like image denoising, object recognition, speech recognition, etc. The most immediate examples could be methods and constitutive systems which perform special cases of text recognition, for example, to solve Captchas or to recognize chemical structures in images.

### LIST OF REFERENCES

1 First example picture with a panda
2 Second example picture with random noise
3 Resulting manipulated example picture
4 Perception of a cube with invariant representations
5 Overview about the single steps of the algorithm
6 Image generator
7 Layer 1
8 Correlation matrix
9 Laplace eigenvector
10 Input vector expressed with laplace eigenvector
11 Layer 2
12 Overall input image
13 One line with color codes
14 Single input images
15 Collected patterns in input images
15a Cutout of visualized laplace eigenvectors
16 Cutout from collected patterns in input images
16a Resulting visualized laplace eigenvectors
17a First layer 1 neuron
17b Second layer 1 neuron
17c Layer 2 neuron
18 Correlation graph with edge weights

1. A method for processing digital image recognition of invariant representations of hierarchically structured entities, performed by a computer using an artificial neural network, comprising the following method steps:
Learning a sparse coding dictionary by the computer on an input signal (14) to obtain a representation of low-complexity components,
Inferring possible transformations from the statistics of the sparse representation by computing a correlation matrix (8) between the low-complexity components with the computer resulting in invariance transformation of the data now encoded in the symmetries of the correlation matrix (8),
Computation of the eigenvectors (9) of the Laplacian operator on the graph (18) whose adjacency matrix is the correlation matrix (8) from the previous step Performing a coordinate transformation to the base of eigenvectors (9) of the Laplacian operator,
Repeating with step one with the next higher hierarchy level (11) until all hierarchy levels (7, 11) of the invariant representations of the hierarchically structured entities are processed and the neural network is trained, and
Using the trained artificial neural network to the digital image recognition of hierarchically structured entities, creating representations of those entities which are invariant under the transformations learnt in the previous steps

2. The method according to claim 1, wherein the sparse coding dictionary learning comprises a first processing step of recognizing patterns (15) in the input signal data (14), wherein those patterns (15) represent specific recurring combinations in the input signal data (14).

3. The method according to claim 1, wherein the representation of low-complexity components is created by computing a correlation matrix (8) of co-occurrences of neuron activations.

4. The method according to claim 1, wherein the next higher hierarchy level (11) gets the result of the coordinate transformation from the base of eigenvectors (9) as input data.

5. The method according to claim 1, wherein the using of the trained artificial neural network to digital image recognition comprises image denoising, object recognition, speech recognition and text recognition.

6. The method according to claim 5, wherein, the text and object recognition comprises to solve captchas or to recognize chemical structures in images.

7. An artificial neural network established on a computer by performing the method according to claim 1.

8. A software product performing the method and establishing an artificial neural network on a computer according to claim 1.
